(19) United States
(12) Patent Application Publication
(10) Pub. No.: US 2016/0239253 A1
(43) Pub. Date: Aug. 18, 2016

(54) METHOD FOR AUDIO CORRECTION IN ELECTRONIC DEVICES

(71) Applicants: Matteo Staffaroni, Burlingame, CA (US); Erhard Schreck, San Jose, CA (US)

(72) Inventors: Matteo Staffaroni, Burlingame, CA (US); Erhard Schreck, San Jose, CA (US)

(21) Appl. No.: 14/604,554

(22) Filed: Jan. 23, 2015

Related U.S. Application Data
(60) Provisional application No. 61/934,154, filed on Jan. 31, 2014.

(51) Int. Cl. G06F 3/16; G10L 25/60

(52) U.S. Cl. CPC G06F 3/165; G06F 3/162; G10L 25/60

(57) ABSTRACT

A method of adjusting frequency based audio levels in an electronic device to compensate for hearing loss without the aid of additional apparatus is disclosed. The device supplies a user with audio stimulus, such as a tone at a set frequency and decibel level, and prompts the user with a question as to whether the tone was audible. This process repeats with multiple stimuli of varying frequency and decibel level. Using the feedback provided by the user in response to the stimulus, the device creates an equalization profile for the user which adjusts the volume of certain frequencies of sound emitted by the device or alters the frequencies altogether in a manner which is consistent with providing audible sound to that user. The user can repeat this calibration process depending on different noise environments and therefore can have a multitude set of equalization profiles. For example the background noise in a car is different than at home or at work and can be adjusted differently.

### CLAIM FOR PRIORITY

The present invention claims priority to U.S. provisional patent application No. 61/934,154, filed on Jan. 31, 2014, by the inventors of the same names.

### FIELD OF THE INVENTION

The present invention relates to the field of sound equalization. The present invention more particularly relates to adjusting frequencies of the sounds emitted by electronic devices in order to compensate for hearing loss.

### BACKGROUND OF THE INVENTION

A well-known problem and eventual limitation of the human body is that of hearing loss. Hearing loss occurs from a multitude of causes some physical and some mental. A common result of hearing loss is the inability or diminished ability to hear certain frequencies of sound normally audible to the human ear. In response to this many turn to hearing aids to compensate for this loss. However, not everyone with hearing issues address the problem in this fashion. Rather some simply attempt to make their lives louder by increasing the volume on the sounds in everyday life, the TV, the radio, the phone.

Increases in volume do not really address the problem of hearing loss because a standard volume dial simply raises the strength of all frequencies of sound, not solely the frequencies that the hearer lacks the ability to hear properly. This practice can both aggravate those surrounding that do not have hearing deficiencies, or potentially cause additional damage to the ear.

A solution similar to that of the hearing aid is to attach an equalizer to adjust the sound emitted by the device in question. This solution generally requires additional hardware. Accordingly, there is a need to adjust the sound emitted by common devices without purchasing additional hardware.

One of the more notable devices wherein the issue of hearing loss is most apparent is the mobile phone. The trend in the manufacture of mobile phones is to improve computing power, while cutting costs elsewhere. Ironically, these cuts are often made to the phone's performance in making calls. To reduce bandwidth of each individual phone on a network, the frequency range emitted during calls is compressed (bandwidth limited). As a result of the compressed frequency range, call quality is diminished. Often, those even without notable hearing loss will have a difficult time understanding the discourse of the call. This is aggravated especially with louder ambient noise.

Despite the lack of quality on calls, mobile phones are capable of generating more clear sounds. A phone playing a music file generally can achieve a wider range of sound frequencies than that of a call simply because the music file resides on the phone and does not have to be transmitted over the cell provider's network. Alternatively, music files that are transferred over the network are done so as compressed data with larger frequency range.

Prior art teaches the use of an equalizer type function to set some limited user preferences as to the sound emitted during phone calls. However, these preferences are limited largely to superficial changes and rely entirely on user set preferences. Accordingly, there is a need for a system with greater adjustment capability.

### INCORPORATION BY REFERENCE

U.S. Pat. No. 8,452,340 entitled, “User-Selective Headset Equalizer for Voice Calls” and U.S. Pat. No. 3,221,100 entitled, “Method and Apparatus for testing Hearing” are incorporated by reference in their entirety and for all purposes to the same extent as if the patents were reprinted here. Additionally, international application PCT/US2004/01528 entitled, “User Interface for Automated Diagnostic Hearing Test” is also incorporated by reference in its entirety and for all purposes to the same extent as if the application was reprinted here.

### BRIEF SUMMARY OF INVENTION

It is an object of the present invention to provide a system wherein an electronic device utilizes user feedback to provided stimulus to calibrate a hearing profile and produce sound more audible to the user.

According to a first aspect of the method of the present invention, a user first initiates calibration on their electronic device. The device then supplies stimulus, such as a tone at a set frequency and decibel level, and prompts the user with a question as to whether the tone was audible. This process repeats with multiple stimuli of varying frequency and decibel level. Using the feedback provided by the user in response to the stimulus, the device creates an equalization profile for the user which adjusts the volume of certain frequencies of sound emitted by the device or alters the frequencies altogether in a manner which is consistent with providing audible sound to that user. Assuming the sound emitting device was capable of being connected to a plurality of speakers, different equalization profiles would be created for each speaker such that changing the sound emitting portion of the device would not hinder the user's ability to audibly understand the output of the device. This calibration affects the frequency behavior of the device itself. It calibrates the entire audio channel from sound source to ear.

The device used in the method of the present invention could be a mobile phone, a television, a radio, a computer or any other suitable sound emitting device commonly found in everyday life.

According to a second aspect of the present invention, the stimulus provided by the sound emitting device would consist of specific words. The words chosen would be those known in the art to be difficult to hear based on known hearing loss conditions. After receiving feedback to stimulus, the device can decide whether the hearing loss in the user was caused by a physical or mental issue. An equalization profile would then be created to address the particular needs of the user. Further, a device that can recognize sounds the device emits as words could alter the words chosen such that the words are emitted with a different inflection which matches the user's equalization profile.

According to a third aspect of the present invention, the stimulus provided by the sound emitting device would consist of recorded voice samplings. The device would record voice samplings from commonly used sources such as a particular television show, a frequent caller, or a often listened to musician. The user would provide feedback as to what if anything in the voice recording was difficult to hear and a equalization profile would be created for that specific source (show, caller, artist, etc.). The device would recognize that the specified source was causing the device to emit sound and the device would apply the specific equalization profile for that source.

### BRIEF DESCRIPTION OF THE DRAWINGS

The subject invention will be more fully understood and appreciated from the following detailed description, taken in conjunction with the drawings in which:

FIG. 1 is a flow chart illustrating the process a sound emitting device takes to establish a equalization profile;

FIG. 2 is a flow chart illustrating recognition and use of different equalization profiles by the same device;

FIG. 3 is a flow chart illustrating the process of voice sample collection; and

FIG. 4 is a flow chart illustrating the process of applying a location based equalization profile.

### DETAILED DESCRIPTION

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims.

Methods recited herein may be carried out in any order of the recited events which is logically possible, as well as the recited order of events.

Unless expressly defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

The disclosed method involves the use of sound emitting electronic devices. These devices would most commonly include a mobile phone. However, other suitable devices would also include televisions, radios, computers, tablets, and other suitable, programmable sound emitting devices which accept user input (“device”). The calls this disclosure refers to may commonly be understood to be those originating from the voice channel on a mobile phone. However, other calls such as those made using the Skype program as marketed by the Microsoft Corporation of Richmond, Wash. or the Hangout program as marketed by Google, Inc. of Mountain View, Calif. or other similar programs known in the art would also suffice as a “call.”

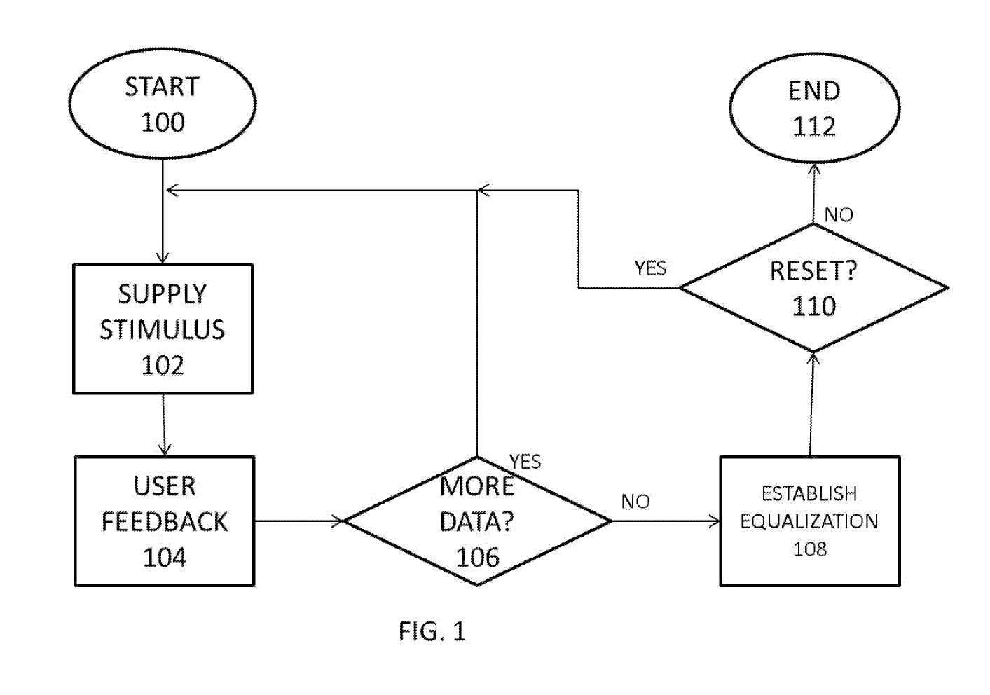

Referring now to FIG. 1, a flow chart illustrating the process a sound emitting device takes to establish an equalization profile. In step 102 a user is supplied with stimulus originating from the device. This stimulus can be a multitude of different sounds. The purpose of the stimulus is to ascertain the hearing ability of the user. Many sounds known in the art are presently used to determine just this. Often simple tones are used. Tones vary in frequency within the audible range. Other options include voice samples, or prerecorded words may be used.

The voice samples would originate from sound recordings of calls placed to the user of the device, or alternatively sound recordings from recorded television or radio shows. Alternatively, this process could be conducted during a live call or show rather than a recording.

In step 104, the user responds to the stimulus provided by the sound emitting device. The user response may be simple as answering if the user was able to hear the tone used. Alternatively, should a prerecorded word be used, the user will be queried as to what the word was. A similar response would be effective if the stimulus used were recordings of calls or shows. The user would be prompted to indicate what the caller, actor, or DJ said.

The process of collecting the data could be done all at once or in multiple sittings (106). A user would be queried by the device if the user wished to provide additional data to the device. Naturally, the more data the device had on the user, the greater the accuracy of the correction the device could provide. Further, a user's hearing would likely change over time. This change could occur during the lifetime of the device. As a result the device would allow additional data to amend the equalization profile, or even reset the data altogether in order to generate a new profile (110).

In step 108, the collected data is analyzed and used to create an equalization profile. An equalization profile is an audio adjustment applied to digital sound emanating from a device. Based on feedback collected from a user in response to stimulus the equalization profile can direct the device to alter the volume of certain frequencies of sound. These alterations would consist of adjusting certain frequencies to target levels as opposed to uniform increases or decreases. Alternatively, certain frequencies of sound can be altered altogether to different frequencies. Another alteration that could be made would consist of slowing down the audio. The slowing of the audio would be most effective on a phone call when audio would not necessarily be synced to a video feed and while speaking to a particularly fast talker. The device would make these adjustments digitally, and without the aid of additional apparatus such as a hearing aid. The chosen adjustments would be made by a mix of both the user accessing user controls on the device interface and automatically by the device responding to user feedback. The exact changes made to the sound emitted by the device occurring automatically are intended to make the sound more audible to the user, are based on equalization data, and are known in the art. This equalization data could come from other independent calibration sources like hearing tests and imported to the device. Depending on the bandwidth of the audio channel, the changes made could be more extensive. An audio channel which only provided for a range of 4 kHz would be harder to make changes to than one with twice that range. Naturally, the wider the original bandwidth of the audio data, the greater the changes that can be made to said audio data to make the data more audible to a user.

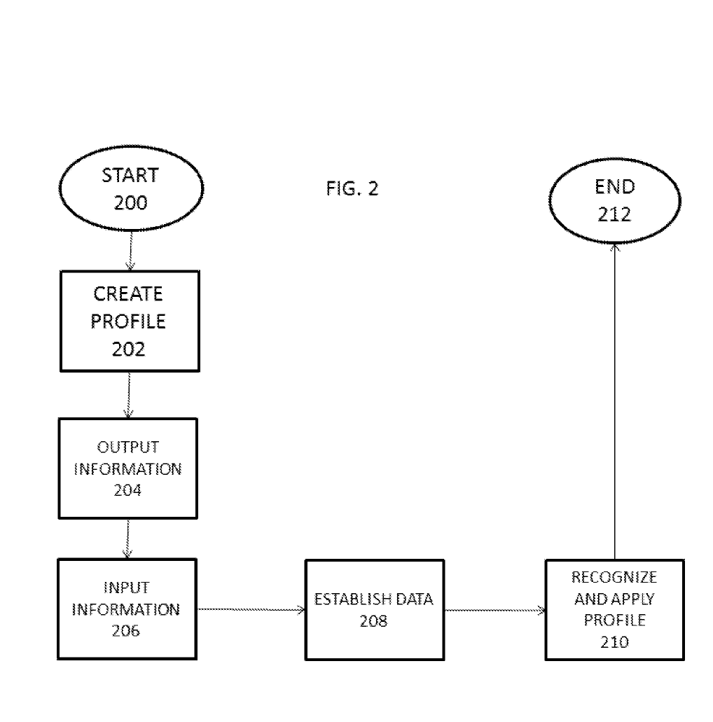

Referring to FIG. 2, a flow chart illustrating recognition and use of different equalization profiles by the same device. In step 202, a user directs a device to create a new sound equalization profile. In step 204 a user provides the device with output information. The output information refers to the speakers which actually produce the sounds emitted by the device. This information can either be functional (i.e. the device already knows the characteristics of this speaker) or managerial (i.e. serves only to identify the profile to the user who personally knows which speaker system is referred to). As an example of various speaker profiles consider a mobile phone's primary speaker as opposed to the speakerphone attached to the same mobile phone. An alternate example would be the difference between the native speakers on a laptop or television and speakers plugged in to an audio jack. The output information field may be left blank such that the equalization profile is only defined by other attributes.

In step 206, the user identifies the input information. The input information refers to the source of the audio. Examples of audio sources would be particular callers, particular radio shows, particular TV shows, or other sources known in the art. This information would be identified by the device in varying ways and depending on the device. With regards to a particular call the device could associate the caller with a particular phone number or service account information. With regards to television programs the device would pull metadata that exists on most television programming boxes to identify which program was currently playing. Further, even a particular actor on a particular program could be identified by using the metadata that goes a long with the close captions to determine which actor would be speaking before said actor in fact spoke. In yet another alternative, radio programs could be identified by the time and station.

In step 208 of FIG. 2, the device collects data as illustrated in FIG. 1. Once the user has identified an equalization profile, that profile requires data collected by the stimulus/feedback process. Each equalization profile would be filled out with unique data that would match the parameters (input/output information) for that particular equalization profile. For example, an equalization profile referring to the speakerphone of a mobile phone would provide all stimuli using the speakerphone speaker. An equalization profile referring to incoming calls from John Smith would provide stimulus matching John Smith's voice.

In step 210, the device recognizes parameters and applies the correct equalization profile for those given parameters and equalizes the sound emitted accordingly.

With reference to multiple equalization profiles, a particular device could come loaded with preset profiles. For example, if the user knows they would have a particularly difficult time hearing baritones speak, a premade profile could be inserted into an equalization profile which would approximate the individual needs of the user based on the assumption that the user had a difficult time hearing baritones. This preset profile would serve as a base from which additional stimuli and feedback would amend the profile such that it fit the particular user better.

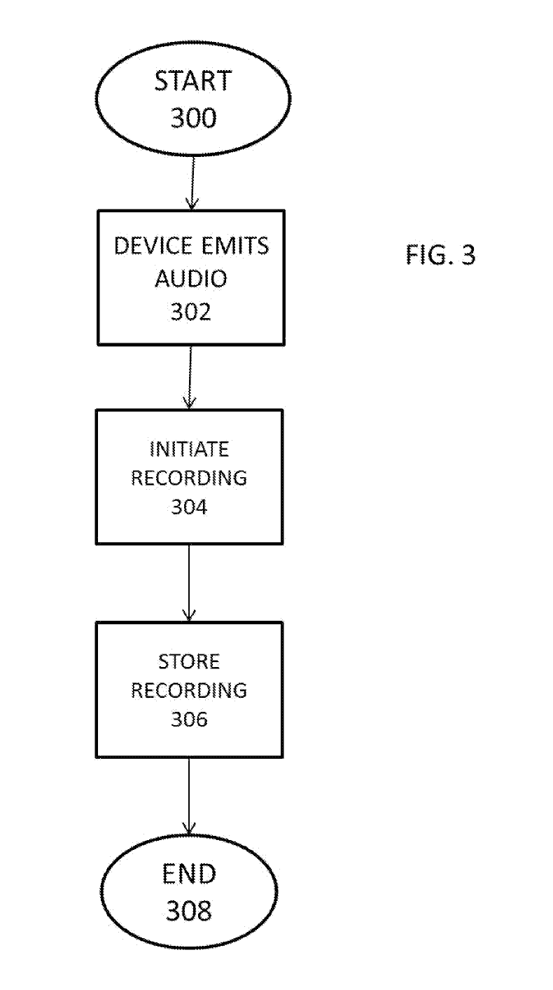

Referring now to FIG. 3, a flowchart illustrating the method of obtaining voice recordings. In step 302, the user engages in the use of a device that is emitting subject audio. In step 304, the user uses the user interface of the device to initiate recording of the subject audio. In step 306, the user directs the device to store the recorded subject audio in onboard device memory.

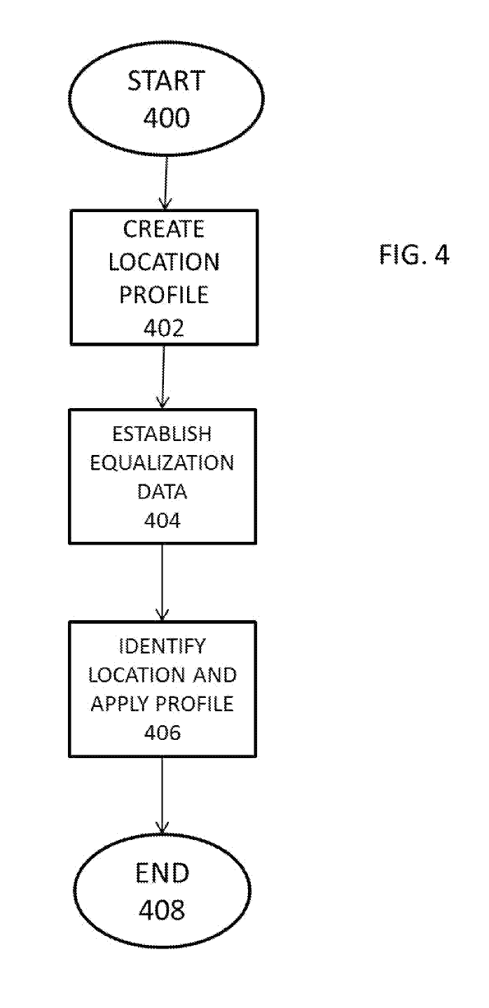

Referring now to FIG. 4, a flow chart illustrating the process of applying a location based equalization profile. In step 402, the user identifies a location profile to be used that would amend an existing profile. The location would be identified via a GPS unit native to the selected device, alternatively by associating a location with a traceable event such as being connected to a certain peripheral (i.e. connecting a device to a work computer would be associated with being at work), or further identified by ambient noise detected by the device microphone. In Step 404, equalization data would be collected by the device in a similar fashion to that described in reference to FIG. 1; however, it would be assumed that the data collected would be associated with the given location specified by the location profile. This feature is premised on the notion that a user's hearing ability would change based upon surroundings. The ambient sounds at work would be different than those at a sports venue. The equalization data could also come from preset profiles that would readily be attached to specified locations

Once a profile for a location was established a device would make note of where it was based on information received from an on board GPS unit or recognizing external event data (i.e. being connected to a peripheral) (Step 406). This location profile would be applied on top of other active equalization profiles and simply amend the other auditory changes already applied. Another example of this process would consist of the device identifying a particularly loud ambient noise at a constant frequency such as the jet engine of a plane. In response to the jet engine, the device would boost the volume of sounds emitted by the device which were at the frequency that matched the frequency of sounds emitted by the jet engine. This would attempt to “yell over” the sounds of the engine at that frequency alone.

The foregoing disclosures and statements are illustrative only of the present invention, and are not intended to limit or define the scope of the present invention. The above description is intended to be illustrative, and not restrictive. Although the examples given include many specifics, they are intended as illustrative of only certain possible applications of the present invention. The examples given should only be interpreted as illustrations of some of the applications of the present invention, and the full scope of the Present Invention should be determined by the appended claims and their legal equivalents. Those skilled in the art will appreciate that various adaptations and modifications of the just-described applications can be configured without departing from the scope and spirit of the present invention. Therefore, it is to be understood that the present invention may be practiced other than as specifically described herein. The scope of the present invention as disclosed and claimed should, therefore, be determined with reference to the knowledge of one skilled in the art and in light of the disclosures presented above.

We claim:

1. A method for configuring a sound emitting electronic device comprising:
emitting plurality of tones at varied pitches;
receiving user feedback data as to the audibility of each of the plurality of tones emitted;
generating an audio profile including feedback data from one or more users;
adjusting the sound described by an audio signal which is available on, electronically or telephonically transmitted to the sound emitting electronic device such that the audio signal falls within an audible range as indicated by feedback data thereby creating an adjusted audio signal; and
playing the adjusted audio signal through the sound emitting electronic device.

2. The method of claim 1 wherein the sound emitting electronic device is a cell phone.

3. The method of claim 2 wherein the audio signal originates from a live telephonic call and is routed through the voice channel of the cell phone.

4. The method of claim 1 wherein the audio signal originates from an audio file available locally on the sound emitting electronic device.

5. The method of claim 1 wherein the audio profile is an equalization profile which specifies specific target levels for a plurality of frequencies and said adjusting the sound comprises raising or lowering the levels of corresponding frequencies of the audio signal to that of the target levels.

6. A method for configuring a sound emitting electronic device comprising:
emitting plurality of recorded audio, the recorded audio comprising spoken words, phrases, or identifiable sounds at varied pitches;
receiving user feedback data as to the comprehension of each of the plurality of recorded audio emitted;
generating an audio profile including feedback data from one or more users;
adjusting the sound described by an audio signal which is available on, electronically or telephonically transmitted to the sound emitting electronic device such that the audio signal falls within an comprehensible range as indicated by feedback data thereby creating an adjusted audio signal; and
playing the adjusted audio signal through the sound emitting electronic device.

7. The method of claim 6 wherein the plurality of recorded audio is recorded speech from a party familiar to a user.

8. The method of claim 6 wherein the sound emitting electronic device is a cell phone.

9. The method of claim 7 wherein the party familiar to a user is an artist or actor commonly associated with a specific subset of media and the sound described by an audio signal is included in the specific subset of media.

10. The method of claim 8 wherein the audio signal originates from a live telephonic call and is routed through the voice channel of the cell phone.

11. The method of claim 6 wherein the audio profile is an equalization profile which specifies specific target levels for a plurality of frequencies and said adjusting the sound comprises raising or lowering the levels of corresponding frequencies of the audio signal to that of the target levels.

12. The method of claim 6 wherein the recorded audio includes spoken words which are specifically difficult to comprehend by users suffering from one or more hearing conditions.

13. The method of claim 6 wherein said receiving of user feedback consists of presenting users with a user interface that allows for a binary response as to the comprehension of the recorded audio.

14. The method of claim 6 wherein said receiving of user feedback consists of presenting users with a user interface that allows for a user to input a textual subjective response as to the comprehension of the recorded audio.

15. The method of claim 14 wherein the sound emitting electronic device stores metadata for the recorded audio including textual descriptions of the content.

16. The method of claim 15 further comprising:
analyzing the textual subjective response as to the comprehension of the recorded audio with reference to the metadata for the recorded audio;
suggesting to the user potential hearing conditions the user suffers from based on discrepancies between the textual subjective response and the metadata for the recorded audio.

17. A system comprising:
A sound emitting electronic device, the sound emitting electronic device including at least one or more speakers, a processor, a memory, and a user interface, the sound emitting electronic device configured to:
emit a plurality of recorded audio, the recorded audio comprising spoken words, phrases, or identifiable sounds at varied pitches through the one or more speakers;
receive user feedback data as to the comprehension of each of the plurality of recorded audio emitted through the user interface;
generate an audio profile including feedback data from one or more users stored on the memory;
adjust the sound described by an audio signal which is available on, electronically or telephonically transmitted to the sound emitting electronic device such that the audio signal falls within an comprehensible range as indicated by feedback data thereby creating an adjusted audio signal; and
play the adjusted audio signal through the sound emitting electronic device through the one or more speakers.

18. The system of claim 17 wherein the one or more speakers vary in performance quality.

19. The system of claim 18 wherein the sound emitting electronic device is configured to generate multiple audio profiles each associated with a different speaker of the one or more speakers.

20. The method of claim 19 wherein the one or more speakers are those of a cell phone or those in an automobile.

21. The method of claim 20 wherein the audio signal originates from a live telephonic call.
